(19) United States
(12) Patent Application Publication
(10) Pub. No.: US 2006/0069646 A1
(43) Pub. Date: Mar. 30, 2006

(54) Method of controlling a terminal device

(76) Inventors: Yoshinori Matsumoto, Saitama (JP); Yuhei Yabe, Tokyo (JP)

Correspondence Address: KATTEN MUCHIN ROSENMAN LLP, 575 MADISON AVENUE, NEW YORK, NY, 10022-2585, US

(21) Appl. No.: 11/238,091

(22) Filed: Sep. 28, 2005

(30) Foreign Application Priority Data
Sep. 28, 2004 (JP) 2004-282335

(51) Int. Cl. G06Q 99/00

(52) U.S. Cl. 705/51

(57) ABSTRACT

A terminal device reliably controlling the usage right with improved convenience is provided. The terminal device reads out a medium identifier held in a computer-readable content recording medium. Usage rights information for each content held in a computer-readable usage rights recording medium is read out, and the usage rights information read out from the usage rights recording medium is set unusable. Authentication information including the readout medium identifier and at least part of the usage rights information for each content is produced and stored, and the stored authentication information is subjected to a predetermined process for determining whether or not to grant access to the content held in the content recording medium.

### BACKGROUND OF THE INVENTION

1. Field of the Invention

The present invention relates to a terminal device for performing a process related to digital content.

2. Related Art

In recent years, an increasing number of terminal devices use a recording medium storing various digital content, and perform a process using the content stored in the recording medium. For example, a music player containing a hard disk or a portable game device plays music stored in the hard disk or reads out a game program or the like optically or magnetically stored in the recording medium, such as a DVD, to perform a game process.

Such terminal devices are associated with problems of controlling the right to use the content. More specifically, if the music content stored in a music player is copied and used without any restriction, the copyright of the copyright holder is infringed. Similar problems may arise for game programs as well.

In order to protect such content, methods for prompting a user to enter a serial number have been suggested, and techniques related to such methods can be found on the Internet. For example, a web site having the URL: http://www.itmedia.co.jp/dict/security/drm/02113.html, can be found through a search on the Internet.

A conventional method of requesting entry of a serial number or the like, however, is not user friendly because it requires bothersome input of the serial number, and cannot restrict the use if even a single legitimate serial number is known.

The present invention has been conceived in view of the above, and an object thereof is to provide a terminal device providing a reliable control over usage right with improved convenience.

### SUMMARY OF THE INVENTION

In order to solve the above-described problems of the conventional art, the present invention according to one aspect provides a method of controlling a terminal device in which a medium identifier held in a computer-readable content recording medium is read out, usage rights information for each content held in a computer-readable usage rights recording medium is read out, the usage rights information read out from the usage rights recording medium is set unusable, and authentication information including the readout medium identifier and at least part of the usage rights information for each content is produced and stored. The stored authentication information is subjected to a predetermined process for determining whether or not to grant access to the content held in the content recording medium.

### BRIEF DESCRIPTION OF THE DRAWINGS

FIG. 1 is a block diagram showing a configuration example of a terminal device according to an embodiment of the present invention.

FIG. 2 is a diagram for describing an example of usage rights information stored in a usage rights recording medium or the like.

FIG. 3 is a schematic view for describing a displayed menu screen.

FIG. 4 is a schematic view for describing an example of a displayed character string.

FIG. 5 is a flowchart of an exemplary process for producing authentication information.

FIG. 6 is a view for describing an example of the content of the authentication information.

FIG. 7 is a view for describing an example of digital content.

### DESCRIPTION OF THE PREFERRED EMBODIMENT

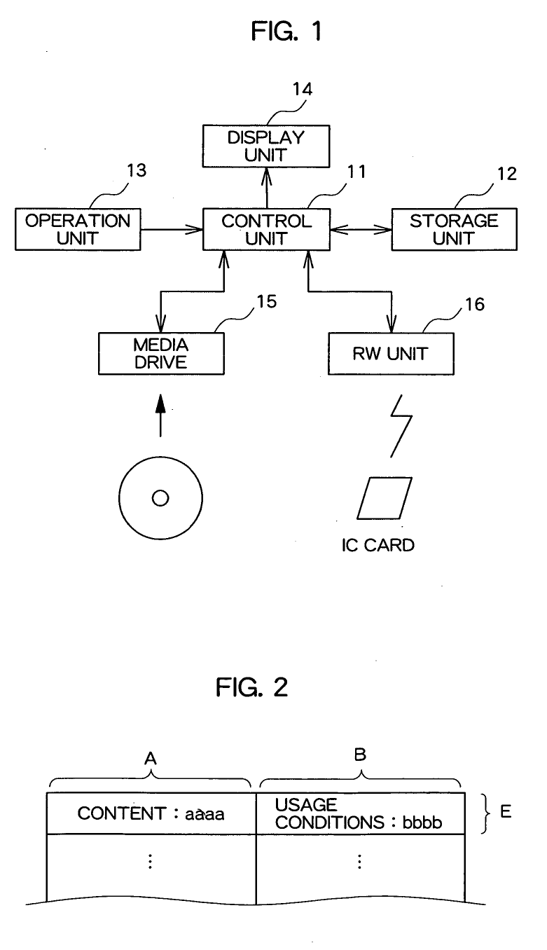

An exemplary embodiment of the present invention will now be described with reference to the accompanying drawings. Referring to FIG. 1, a terminal device according to an embodiment of the present invention includes a control unit 11, a storage unit 12, an operation unit 13, a display unit 14, a media drive 15, and a reader/writer unit (hereinafter simply referred to as an “RW unit”) 16.

The control unit 11, such as a CPU, operates in accordance with a program stored in the storage unit 12. According to this embodiment, the control unit 11 performs a process of producing authentication information, a process of determining whether or not to grant access to a digital content using the produced authentication information, and a process based on the accessed content. The processes performed by the control unit 11 will be discussed in more detail hereinafter.

The storage unit 12, such as a RAM (random access memory) or a ROM (read only memory), holds the program run by the control unit 11. The storage unit 12 also functions as a work memory for holding a variety of data necessary for the processes performed by the control unit 11. In this embodiment, a unique terminal identifier assigned to each terminal device is pre-recorded in the storage unit 12.

The operation unit 13, such as a button, a switch, or a touch panel, receives an instruction operation from a user, and provides the content of the instruction operation to the control unit 11. The display unit 14, such as a liquid crystal display, displays an image based on the instruction provided from the control unit 11.

The media drive 15 performs processes of, for example, receiving a computer-readable recording medium, such as a DVD (digital versatile disk), to read out the data stored in the recording medium in accordance with an instruction provided from the control unit 11 and supply the data to the control unit 11, and recording the data provided from the control unit 11 in the recording medium.

The RW unit 16 accesses an IC card substantially in contact therewith, or located close thereto within a range of several meters, and reads out and supplies the data recorded in the IC card to the control unit 11. The RW unit 16 records the data supplied from the control unit 11 in the IC card. In the present embodiment, the RW unit 16 may be included in a housing of the terminal device, or may be externally connected through an interface such as a USB (universal serial bus).

In the following description, it will be assumed that digital content is recorded in the recording medium received by the media drive 15. In other words, the recording medium received by the media drive 15 corresponds to a content recording medium of the present invention. Accordingly, the recording medium received by the media drive 15 will be hereinafter referred to as a content recording medium. An IC card accessed by the RW unit 16 includes a communication circuit for use in communication between a memory and the RW unit 16 by means of a wireless communication technique such as Bluetooth or through electromagnetic coupling, and a CPU for accessing the memory in accordance with an instruction supplied from the RW unit 16, and reading and sending, or rewriting, the content therein. It will be assumed that usage rights information is recorded in the memory of the IC card. That is, the IC card corresponds to a usage rights recording medium of the present invention. Accordingly, the IC card will be hereinafter referred to as a usage rights recording medium.

One of the characteristic features of the present embodiment is that a medium identifier is recorded in the content recording medium, and that usage rights information for each content is held in the usage recording medium. The medium identifier recorded in the content recording medium may be encrypted. The usage rights information includes at least one entry (E) associating information (A) specifying digital content with information (B) indicating the usage conditions of the content specified by the information (A), as in an example shown in FIG. 2. For description purposes, the digital content will be hereinafter assumed as a program (such as a game program) that can be executed by the control unit 11.

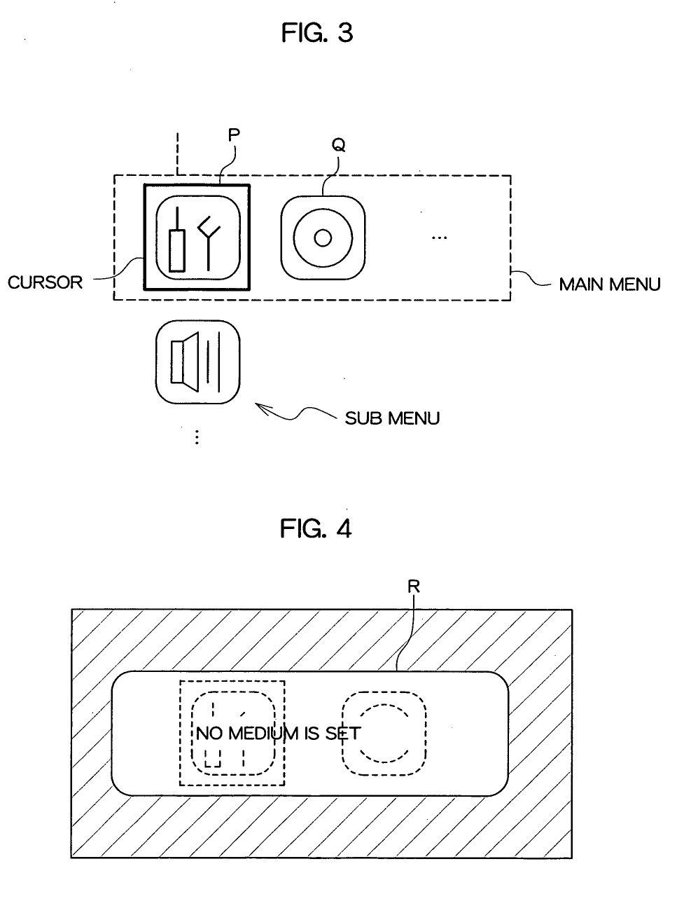

Upon power on, the control unit 11 of the present embodiment reads out, and starts execution of, the program stored in a predetermined region of the storage unit 12. More specifically, as shown in FIG. 3, the control unit 11 presents, as a startup screen, a main menu screen including an icon (P) for setting a variety of factors to be adjusted, such as the volume, and an icon (Q) for indicating an instruction to read out and execute a program in the content recording medium.

A user of the terminal device operates the operation unit 13 to move a cursor on the icon for causing execution of a desired process. Assuming that, for example, the icon related to setting is selected, a sub menu for specifying the factor to be set is displayed and the cursor is moved on the sub menu. According to the present embodiment, in order to facilitate such a selection operation, the cursor is arranged and displayed one-dimensionally in a virtual straight line on the main menu screen, and the sub menu is listed in a direction perpendicular to the virtual straight line where the menu icons are arranged. As a result, for moving the cursor on the main menu, the user first operates the cursor to move horizontally, and, when he/she operates it to move vertically, the cursor is controlled to move on a sub menu screen related to the selected menu icon. More specifically, if, for example, buttons are arranged in four directions, i.e. top, bottom, right, and left, on the operation unit 13, the icon on the main menu can be selected by operating the button in the horizontal direction, and, with the desired menu icon selected, the user operates the button in the vertical direction, so that the sub menu can be immediately accessed, thereby achieving a high operability.

When the icon (Q) indicating that an instruction to be read out and executed, a program in the content recording medium is selected and an operation to instruct “execution” is performed, the control unit 11 checks whether or not the content recording medium is set in the media drive 15, and, if not, displays on the display unit 14 a character string indicating that no content recording medium is set, and waits until the medium is set. In displaying the character string, the contrast of the displayed menu screen described above is decreased (in the figure, the peripheral area is hatched and the icons on the menu are indicated by a broken line for illustrative purposes), a box (R) for displaying the character string is displayed, and in this box the character string is displayed in a color having a relatively high contrast than the background color (FIG. 4). As a result, readability of the character string is improved utilizing the characteristics of human eyes preferentially capturing an image having a relatively high contrast.

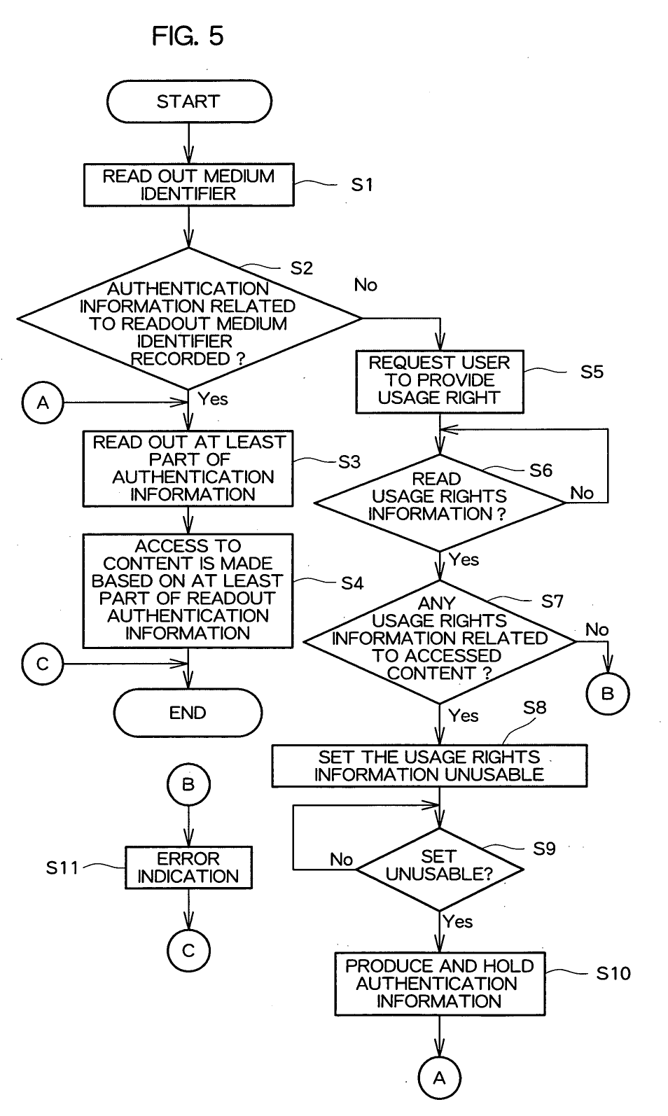

The control unit 11 starts processing shown in FIG. 5 if the content recording medium is already set, or when it has just been set (i.e. when it has received the content recording medium) The unit first reads out the medium identifier from the content recording medium (S1), and checks whether or not authentication information related to that particular medium identifier is stored in the storage unit 12 (S2). If the authentication information related to that medium identifier is stored (i.e. if YES), the unit reads out information specifying the digital content included in the authentication information and the usage conditions of the content specified by that information (S3), and starts processing for accessing the content based on the readout usage conditions (S4). The process for accessing the content will be described further in detail.

On the other hand, if the authentication information related to that medium identifier is not stored at the step S2 (i.e. if NO), the process for producing the authentication information is started. More specifically, the control unit 11 displays on the display unit 14 a character string or the like that requests a user to provide usage rights information (S5), and waits until the RW unit 16 reads the usage rights information from the IC card (S6). Upon display at the step S5 as well, the image is displayed in such a manner that readability of the character string or the like requesting the user to present usage rights information is improved, as illustrated in FIG. 4.

When the IC card, i.e. the usage rights recording medium, comes close to the RW unit 16 into the readable range, the RW unit 16 reads out usage rights information (or a plurality of usage rights information items, if any) stored in the usage rights recording medium, and outputs the information to the control unit 11. When the usage rights information is input, the control unit 11 determines whether or not the input usage rights information includes usage rights information having information specifying the digital content (the one designated as the accessed content) stored in the content recording medium, i.e. the usage rights information corresponding to the content (S7). If the usage rights information corresponding to the content is included (i.e. if YES), the unit 11 instructs the RW unit 16 to set the usage rights information corresponding to the content to unusable (S8). The RW unit 16 sets the usage rights information to unusable so as to correspond to the content and stored in the usage rights recording medium by, for example, deletion, and confirms whether or not the setting is reflected. After confirmation, the unit reports this to the control unit 11.

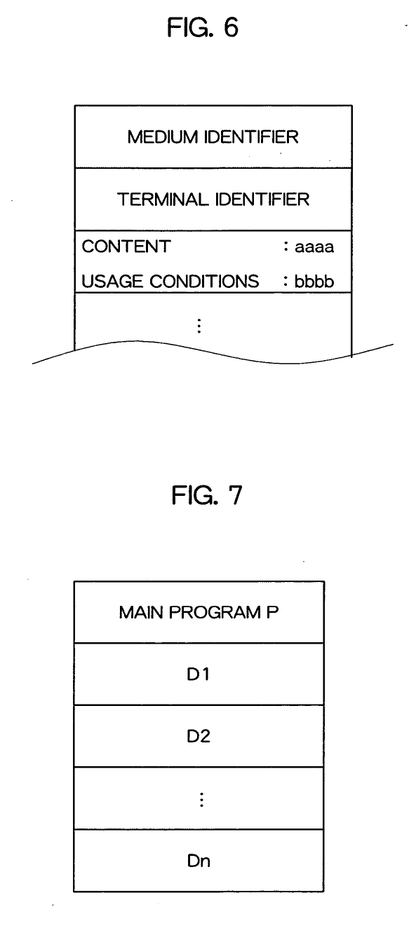

When the control unit 11 is informed that the usage rights information is set unusable and the setting has been confirmed (S9), the unit produces the authentication information, and stores the authentication information in the storage unit 12 (S10) It should be noted that the authentication information includes the medium identifier stored in the content recording medium, the terminal identifier prestored in the storage unit 12, the information specifying the content included in the usage rights information, and the information indicating the usage conditions, as shown in FIG. 6. The control unit 11 proceeds to the step S3, and continues processing (A).

If the usage rights information corresponding to the content does not exist (if NO) at the step S7, the control unit 11 causes the display unit 14 to display an indication that the user has no usage right (error indication) (S11), and terminates the process (C).

According to the present embodiment, an inquiry as to usage conditions is made in the processing of an application stored in the content recording medium. As a specific example, the control unit 11 executes an application program interface (API) process providing information related to usage conditions based on a request from the application program. In the API processing, the control unit 11 receives the request to provide information related to usage conditions from the application program, and reads out from the storage unit 12 the authentication information related to the medium identifier of the content recording medium storing that application program. The unit then supplies the information specifying the content included in the authentication information and the information on usage conditions to the application program. The procedures of exchanging information between the application program and API are widely known in the field of general operating system implementation, and therefore will not be described in detail.

Next, the content accessing process performed at the step S4 in FIG. 5 will be specifically described. The digital content of the present embodiment includes, for example, a game program. Referring to FIG. 7, the content of the game program includes a main game program (main program P) as an application program, and data (D1, D2, . . . , Dn) for a plurality of content elements (scenes) provided as the game progresses. According to the present embodiment, the usage conditions include information specifying an accessible content element among such a plurality of content elements.

More specifically, the plurality of content elements in the game program are associated with corresponding identifiers (such as a number assigned in the order of appearance) and stored in the content recording medium. The information on usage conditions corresponding to the content is associated with information indicating usable or unusable for each identifier, and stored in the usage rights recording medium.

The control unit 11 refers to the information on usage conditions corresponding to the content to be performed, and determines whether or not there is a content element set to usable. If there is a content element set to usable, the control unit 11 instructs the media drive 15 to read the main program P from the content recording medium. The unit causes the storage unit 12 to store the readout main program P, and initiates the process (causing the game processing to be initiated).

In the main program P, the content element is read out as the game progresses. Prior to readout, the main program P causes the control unit 11 to determine whether the user has usage rights for the content element to be read out.

More specifically, based on the main program P, the control unit 11 requests the API to provide information on usage conditions. The control unit 11 then initiates the process as the API, and, in response to the request, reads out from the storage unit 12 the authentication information related to the medium identifier of the content recording medium storing the application program. The unit supplies the information on usage conditions included in the authentication information to the application program, and terminates the process as the API.

The control unit 11 then returns to the processing of the main program P, and refers to the information on usage conditions output from the API to determine whether or not the information on usage right corresponding to the identifier of the content element (such as Data Di) to be read out indicates “usable”. If usable, the control unit 11 reads out data Di of the content element to be read out, and performs a process in the main program P using the data Di of the content element.

The terminal device of the present embodiment configured as described above operates in the following manner. Upon purchase of digital content from a content sales distributor, a user asks for the usage rights information to be recorded in the IC card, i.e. the usage rights recording medium.

The user first sets the content recording medium including the content to be performed into the media drive 15 of the terminal device, and turns on the terminal device. Execution of an activating program is initiated, and a main menu screen is displayed. When the user of the terminal device moves a cursor over an icon to provide an instruction to read out and execute a program in the content recording medium, the terminal device starts the processing shown in FIG. 5 because the content recording medium is already set. The medium identifier is read out from the content recording medium, and it is determined whether or not the authentication information related to that medium identifier is stored in the storage unit 12.

Assuming that the authentication information is not stored, the terminal device starts a process for producing authentication information, and a character string or the like requesting presentation of usage rights information, such as “Hold up a usage right card”, is displayed. When the user holds the IC card recording the usage right corresponding to the content over the terminal device, the RW unit 16 reads out the usage rights information from the IC card.

The terminal device determines whether or not the usage rights information contains the usage rights information including the information specifying the content stored in the content recording medium (usage rights information corresponding to the content). If the usage rights information corresponding to the content is contained, it instructs the RW unit 16 to set the usage rights information corresponding to the content to unusable. The RW unit 16 deletes the usage rights information corresponding to the content and recorded in the IC card serving as the usage rights recording medium, and confirms completion of deletion. After confirming the deletion, the terminal device produces the authentication information, and holds it in the storage device 12.

The terminal device then refers to the authentication information produced corresponding to the set medium identifier, and reads out information on usage conditions corresponding to the content for which execution is instructed from the authentication information. If the information on usage conditions indicates the content as usable, the device reads out the content for which execution is instructed from the content recording medium, and starts execution.

Even if fraudulent use of the content recording medium is attempted, the usage rights information of the content stored in the content recording medium is not held in other terminal devices (even if the user already has the usage right of the same content, he/she is regarded as having no usage right because the medium identifier is different), fraudulent use of the content can be avoided. If used content recording media are distributed, a purchaser of the used content recording medium can perform the content if he/she also acquires the usage right. Thus, the present embodiment can reliably control the usage right with improved convenience.

Further, the authentication information includes the terminal identifier as shown in FIG. 6. Therefore, in the API processing responding to the usage condition request, the control unit 11 may provide the application program with an error response that there is no usage condition (or “unusable” is indicated) if the terminal identifier stored in the storage unit 12 (its own terminal identifier) does not match the terminal identifier associated with the medium identifier related to the request.

Receiving the error response, the application program can perform the processing in accordance with the response, such as controlling not to access the content. As a result, even if the authentication information is copied and transferred to another terminal device, fraudulent use of the content can be avoided because the terminal identifier is different for other devices.

In one embodiment of the present invention, the usage rights recording medium and the content recording medium may be integrated, rather than provided as two separate items. More specifically, an IC chip serving as the usage rights recording medium may be embedded in the content recording medium. In such a case, the RW unit 16 reads out information recorded in the IC chip in the content recording medium set in the media drive 15, rather than the IC card, and writes/deletes information to/from the IC chip.

Further, in such a case, the IC chip need not always be provided therein, and the usage rights information may be recorded in a DVD disk or the like serving as the content recording medium. In such a configuration, the RW unit 16 itself need not be provided, and the media drive 15, instead of the RW unit 16, reads, writes, and deletes the usage rights information.

While as digital content, an application program, such as a game program, has been described by way of example, the present invention is not limited thereto. For example, the content described here may be film image data, music data, or the like. In such a case, the information specifying the content element may be first 10 minute data of a film, or information specifying a certain scene. This makes it possible to perform a process for accessing only to that content element, thereby allowing a user to preview the content prior to purchase.

The usage condition information is not limited to that indicating usable or unusable, and may indicate expiration date. In such a case, the control unit 11 determines whether or not the usage period has expired by referring to an unillustrated calendar or clock. Alternatively, the number of usage times may be used. In this case, the number of usage times is decremented and the usage rights information in the usage rights recording medium is rewritten every time the usage rights information is read from the usage rights recording medium or the like, and the usage rights information may be deleted when the number hits “zero”.

What is claimed is:

1. A method of controlling a terminal device capable of reading information from a usage rights recording medium located close thereto in a readable range, comprising:
a step of causing the usage rights recording medium to record usage rights information corresponding to content to be processed;
a step of setting a content recording medium storing the content in the terminal device, and instructing initiation of a process; and
a step of bringing the usage rights recording medium recording the usage rights information corresponding to the content close to the terminal device in the range readable by the terminal device, causing readout, and receiving from the terminal device a setting for rendering unusable the usage rights information recorded in the usage rights recording medium.

2. A method of controlling a terminal device, comprising:
a step of reading a medium identifier held in a computer-readable recording medium;
a step of reading usage rights information for each content held in the computer-readable recording medium, and setting the usage rights information read out from the recording medium to unusable; and
a step of producing and storing authentication information including the readout medium identifier and the usage rights information for each content; wherein
the stored authentication information is subjected to a predetermined process for determining whether or not to grant access to the content held in the recording medium.

3. A control method according to claim 2, wherein
when the content recording medium is received, the medium identifier held in the content recording medium is referred to, and a process of requesting a user to enter usage rights information is performed if the authentication information related to the medium identifier is not stored.

4. A control method according to claim 2, wherein
the terminal device includes an IC card reader/writer unit for accessing an IC card and reading and writing data, and
the usage rights recording medium is an IC card reader, and access to the usage rights information is made through the IC card reader/writer.

5. A method of controlling a terminal device, comprising:
a step of reading a medium identifier held in a computer-readable content recording medium;
a step of reading usage rights information for each content held in the content recording medium, and setting unusable the usage rights information read out from the content recording medium; and
a step of producing and storing authentication information including the readout medium identifier and the usage rights information for each content; wherein
the stored authentication information is subjected to a predetermined process for determining whether or not to grant access to the content held in the content recording medium.

6. A control method according to claim 2, wherein
the content includes a plurality of content elements,
the usage rights information includes information specifying an accessible content element among the plurality of content elements, and
the stored authentication information is subjected to a predetermined process for determining whether or not to grant access to each content element of the content held in the recording medium.

7. A control method according to claim 5, wherein
the content includes a plurality of content elements,
the usage rights information includes information specifying an accessible content element among the plurality of content elements, and
the stored authentication information is subjected to a predetermined process for determining whether or not to grant access to each content element of the content held in the recording medium.

8. A control method according to claim 2, wherein
when the content recording medium is received, the medium identifier held in the content recording medium is referred to, and, if the authentication information related to the medium identifier is stored, access is made to the content based on the usage rights information included in the authentication information.

9. A control method according to claim 5, wherein
when the content recording medium is received, the medium identifier held in the content recording medium is referred to, and, if the authentication information related to the medium identifier is stored, the content is accessed based on the usage rights information included in the authentication information.

10. A control method according to claim 2, wherein
the authentication information further includes a terminal identifier assigned uniquely to the terminal device, and
if the terminal identifier of the stored authentication information does not match its own terminal identifier, an authentication process based on the authentication information is controlled not to be performed.

11. A control method according to claim 5, wherein
the authentication information further includes a terminal identifier assigned uniquely to the terminal device, and
if the terminal identifier of the stored authentication information does not match its own terminal identifier, an authentication process based on the authentication information is controlled not to be performed.

12. A terminal device, comprising
a device for reading out a medium identifier held in a computer-readable content recording medium;
a device for reading out usage rights information for each content held in the computer-readable usage rights recording medium, and setting unusable the usage rights information read out from the usage rights recording medium; and
a device for producing and storing authentication information including at least part of usage rights information for each content and the readout medium identifier; wherein
the stored authentication information is subjected to a predetermined process for determining whether or not to grant access to the content held in the content recording medium.
